(19) United States
(12) Patent Application Publication
(10) Pub. No.: US 2009/0099900 A1
(43) Pub. Date: Apr. 16, 2009

(54) IMAGE DISPLAY DEVICE INTEGRATED WITH CUSTOMER DEMOGRAPHIC DATA COLLECTION AND ADVERTISING SYSTEM

(76) Inventors: Thomas R. Boyd, Lake Barrington, IL (US); James W. Boyd, Naperville, IL (US)

Correspondence Address: PARK LAW FIRM, 3255 WILSHIRE BLVD, SUITE 1110, LOS ANGELES, CA, 90010, US

(21) Appl. No.: 11/869,879

(22) Filed: Oct. 10, 2007

(51) Int. Cl. G06Q 30/00; G06F 17/40; G06F 19/00

(52) U.S. Cl. 705/10; 345/173

(57) ABSTRACT

The present invention provides for an image display device, capable of producing a simulated 3-D image, integrated with a customer demographic data collection system that gathers user information by using video mining software and an advertising system that communicates the desired message to the user. The present invention allows for immediate, near real-time data collection for interpretive analysis while simultaneously delivering messages through an innovative advertising medium. The image display device allows for user interaction that can be detected via a sensor and interpreted via an information processing device. Customer demographic data collected include, but not limited to, age range, gender, ethnicity, number of users, time spent waiting in queue, number of impressions, time of impressions, number of touch screen hits, and number of image hits.

### BACKGROUND OF THE INVENTION

The present invention relates to an image display device integrated with a customer demographic data collection and advertising system.

More particularly, the present invention relates to an image display device capable of producing a simulated 3-D image, integrated with a customer demographic data collection system which gathers information by using video mining software, and an advertising system that communicates the desired message to the user.

According to the prior art, advertisements are disseminated via traditional media such as television, newspapers, magazines, and internet websites. The prior art allows for only very limited information to be gathered from the customers, such as the number of views or viewers. In order for advertisers and market researchers to gather more information from their customers, they had to rely on surveys of relatively small samples to obtain the desired information. The traditional methods of customer demographic data collection can be very time consuming, expensive, and inaccurate.

### SUMMARY OF THE INVENTION

The present invention contrives to solve the disadvantages of the prior art.

An objective of the invention is to collect accurate, reliable, and more comprehensive customer demographic data that produces business intelligence while simultaneously providing an innovative, novel, and effective advertising medium that attracts customers.

Another objective of the invention is to provide immediate, near real-time customer demographic data collection without being limited to surveys of small samples of users.

Still another objective of the invention is to allow for quick and easy way to remotely manage transmittal of advertising messages and collection of demographic data.

In order to achieve the above objectives, the present invention provides an image display device that includes an advertising system, a customer demographic data collection system and an information processing device that controls the advertising system and the customer demographic data collection system.

The advertising system comprises an image display module and an audio reproduction module. The advertising system retrieves image data and audio data from the information processing device and displays the image data with the image display module and reproduces the audio data with the audio reproduction module per control of the information processing device.

The customer demographic data collection system comprises a video capture module that is adapted to capture video data and sends the captured video data to the information processing device.

The information processing device comprises a video mining module, a controlling module that controls the operation of the advertising system and the customer demographic data collection system, a networking module that sends/receives data over an internetwork.

The video mining module analyzes the captured video data and produces customer demographic data.

The image display module comprises a case comprising an opening, a luminous source image display displaying a first image and positioned within the case, a focusing element positioned within the case and receiving light from the source image display and focusing the light to form a second image that is viewable through the opening of the case, a sensor that is adapted to sense the existence and/or position of the body part of a customer around the opening.

The image display module displays the image data interactively according to the existence and/or position data obtained by the sensor. The user is able to reach inside the opening of the case and interact with the simulated 3-D image so that the content of the advertisement or image can be changed.

The customer demographic data produced by the video mining module comprises age range, gender, and ethnicity of the customers.

The customer demographic data further comprises impression time of the customers.

The advertising system further comprises a touch screen and a coupon portal. The touch screen provides menus for selection by the customer. The coupon portal prints out a predetermined coupon per selection of the customer.

The customer demographic data further comprises number of coupons dispensed, and number of touch screen hits by the customer.

The customer demographic data further comprises number of hits on the image displayed by the image display module.

The customer demographic data further comprises number of users, time spent in a waiting queue, and total number of impressions.

The image data and audio data are updated via the networking module.

The advantages of the present invention are that: (1) it is an efficient, measurable, and cost-effective advertising medium that is new, fun, and innovative compared to traditional digital media vehicles; (2) it provides reliable and immediate marketing and demographic statistics; and (3) it allows for near real-time demographic information collection via video mining that can measure consumer impressions, behavior, and attitude. The system is networked for ease of maintenance, content change, and information gathering.

The present invention provides an interactive advertising mechanism that allows gathering of information based on how the user interacts with the present invention. The present invention utilizes sight, sound, and touch to engage the user. The user sees the simulated 3-D images and hears audible advertising messages. The user can reach inside the case opening and interact with the image, where the sensor system communicates the interaction to the computer. The content of the advertisement or image can change based on user movement and interaction within the case opening.

The present invention is capable of video mining, which can recognize various features of a user, such as approximate age, gender, and ethnicity.

The present invention allows for immediate interpretive analysis based on the information gathered. Near real-time demographic information can be collected via video-mining. Measurements such as impression time, number of users, number of touch screen hits, number of 3-D image hits, number of coupons dispensed, number of coupons redeemed, time spent in queue, and total number of impressions can be collected. The data gathered can be reported near real-time via the internet. Demographic data is collected more easily and quickly without subjecting users to fill out a long survey. The present invention can be accessed remotely via the internet, allowing a data administrator to manage data collection and advertising content anywhere, anytime.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing an image display device according to the present invention;

FIG. 2 is a schematic diagram showing components of the image display device;

FIG. 3 is a block diagram showing hardware elements of the image display device;

FIG. 4 is a schematic diagram showing central processing of data collected from multiple image display devices; and

FIG. 5 is a block diagram showing the image display device.

### DETAILED DESCRIPTION OF THE INVENTION

Disclosures of U.S. Pat. No. 6,964,487 issued on Nov. 15, 2005, U.S. Pat. No. 7,001,033 issued on Feb. 21, 2006, U.S. patent application Ser. No. 11/298,405 filed on Dec. 9, 2005, and U.S. patent application Ser. No. 11/225,621 filed on Sep. 12, 2005 by the applicants are incorporated by reference as if they are fully set forth herein.

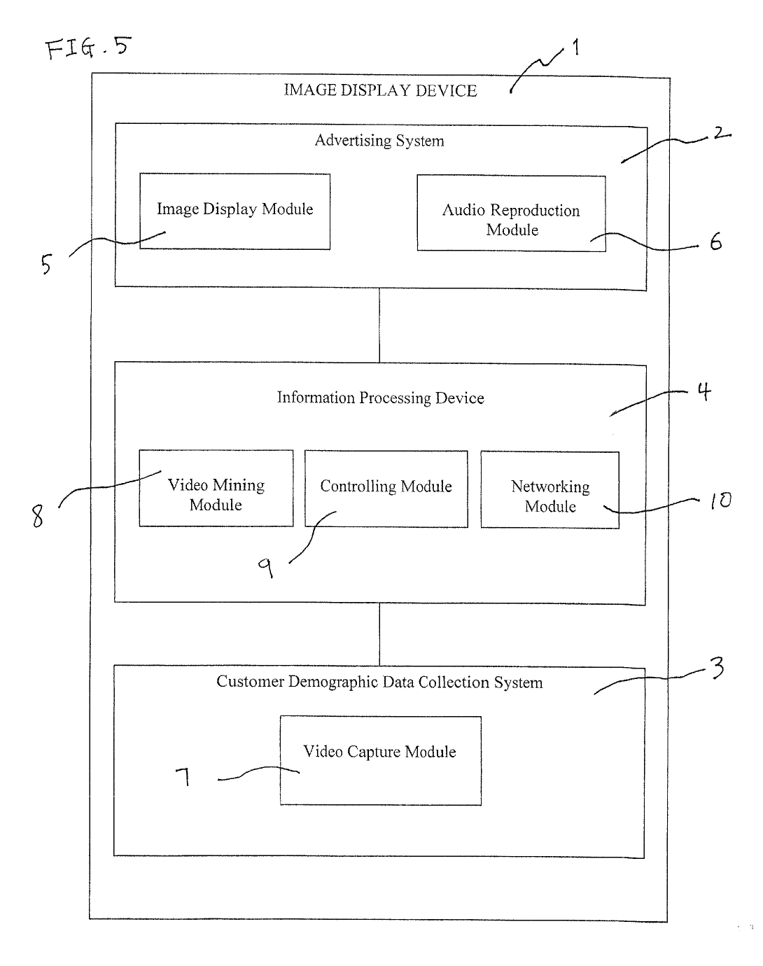

FIG. 5 shows an image display device 1 that includes an advertising system 2, a customer demographic data collection system 3 and an information processing device 4 that controls the advertising system 2 and the customer demographic data collection system 3.

The advertising system 2 comprises an image display module 5 and an audio reproduction module 6. The advertising system 2 retrieves image data and audio data from the information processing device 4 and displays the image data with the image display module 5 and reproduces the audio data with the audio reproduction module 6 per control of the information processing device 4.

The customer demographic data collection system 3 comprises a video capture module 7 that is adapted to capture video data and sends the captured video data to the information processing device 4.

The information processing device 4 comprises a video mining module 8, a controlling module 9 that controls the operation of the advertising system 2 and the customer demographic data collection system 3, a networking module 10 that sends/receives data over an internetwork.

The video mining module 8 analyzes the captured video data and produces customer demographic data.

The image display module 5 comprises a case 11 comprising an opening 12, a luminous source image display 13 displaying a first image and positioned within the case 11, a focusing element 14 positioned within the case 11 and receiving light from the source image display 13 and focusing the light to form a second image that is viewable through the opening 12 of the case 11, a sensor 15 that is adapted to sense the existence and/or position of the body part of a customer around the opening 12.

The image display module 5 displays the image data interactively according to the existence and/or position data obtained by the sensor 15. The user is able to reach inside the opening 12 of the case 11 and interact with the simulated 3-D image so that the content of the advertisement or image can be changed.

The customer demographic data produced by the video mining module 8 comprises age range, gender, and ethnicity of the customers.

The customer demographic data further comprises impression time of the customers.

The advertising system 2 further comprises a touch screen 16 and a coupon portal 17. The touch screen 16 provides menus for selection by the customer. The coupon portal 17 prints out a predetermined coupon per selection of the customer.

The customer demographic data further comprises number of coupons dispensed, and number of touch screen hits by the customer.

The customer demographic data further comprises number of hits on the image displayed by the image display module 5.

The customer demographic data further comprises number of users, time spent in a waiting queue, and total number of impressions.

The image data and audio data are updated via the networking module 10.

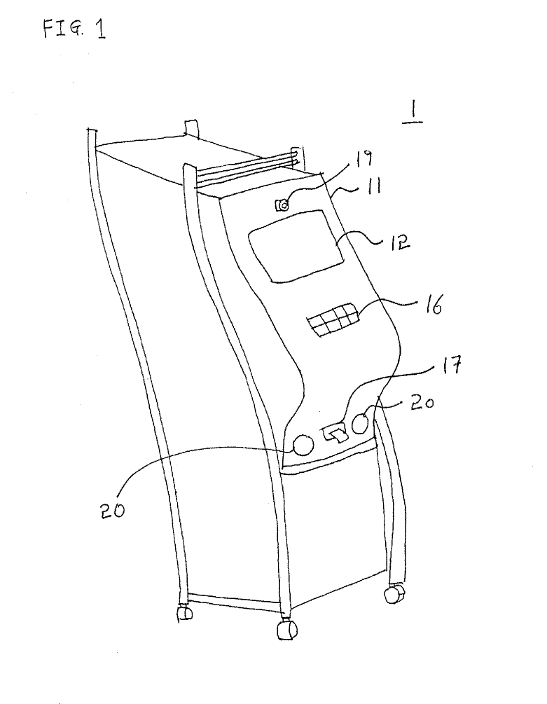

FIG. 1 is a perspective view of the image display device 1 according to the present invention. The video capture module 7 is a digital camera 19 that is positioned on the case 11 so that demographic data of the user can be collected. A preferred embodiment of the present invention has the digital camera 19 positioned above the case opening 12. FIG. 1 also shows the touch screen 16 positioned below the case opening 12, a pair of surround-sound speakers 20 positioned below the touch screen 16, and a coupon portal 17 positioned in between the surround-sound speakers 20.

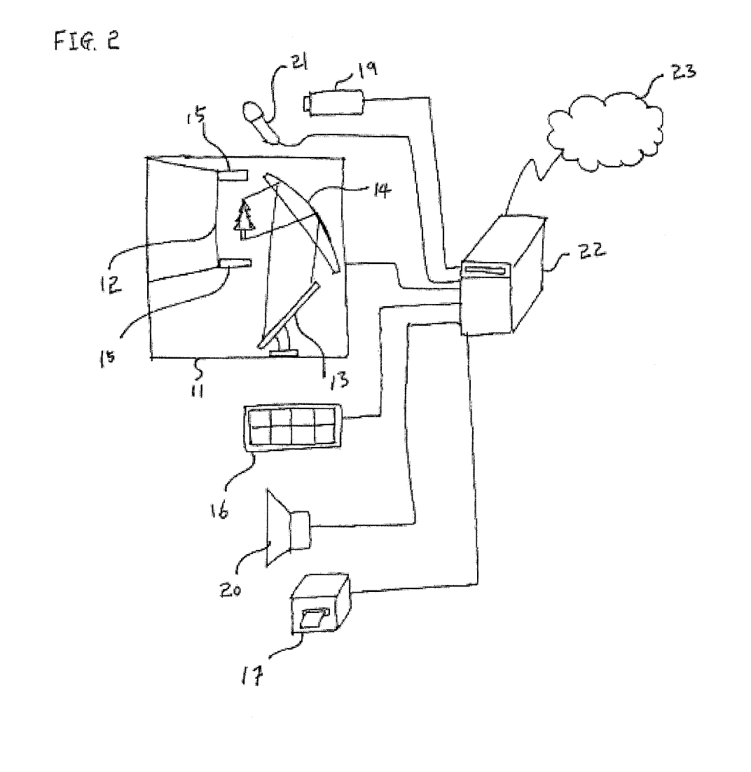

FIG. 2 is a schematic diagram showing components of the image display device 1. FIG. 2 depicts how various information gathered via a digital camera 19, a microphone 21, and the touch screen 16, are fed into the local computer 22, which is the information processing device 4. FIG. 2 also depicts various output information produced via the surround-sound speakers 20 and coupon portal 17. The local computer 22 relays information to and from the internetwork 23.

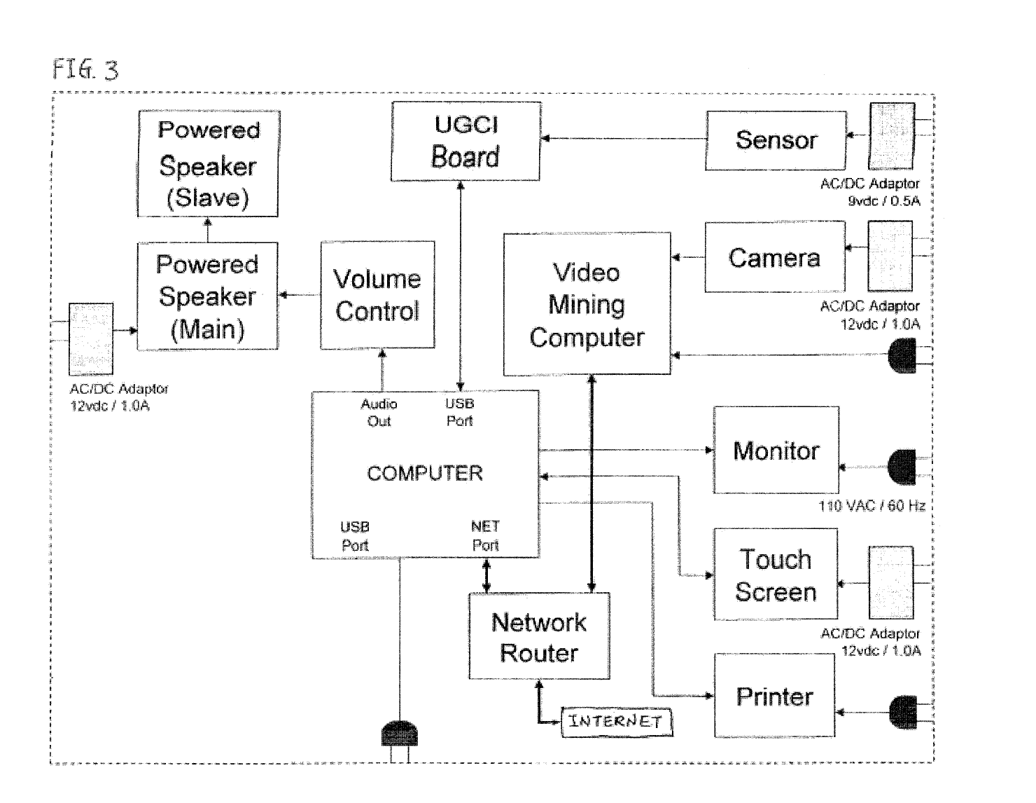

FIG. 3 is a block diagram showing hardware elements of the image display device 1.

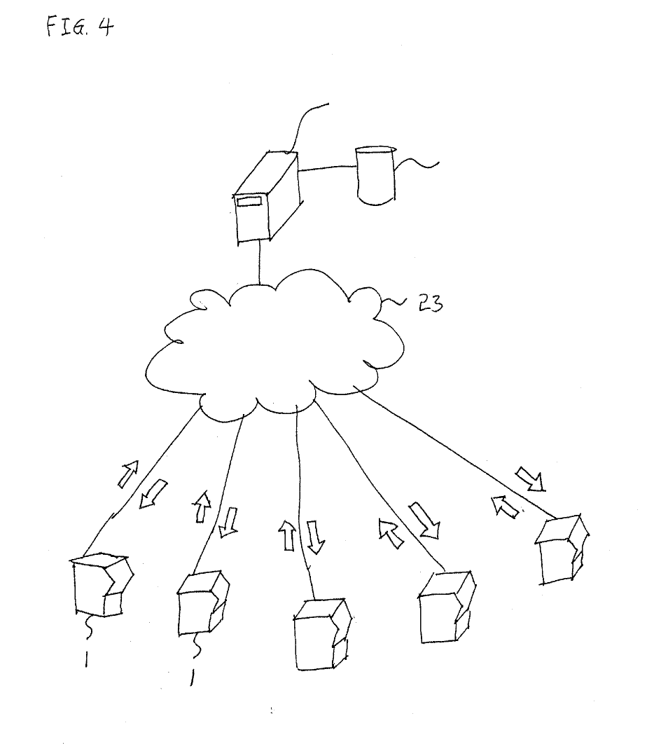

FIG. 4 is a schematic diagram showing central processing of data collected from multiple image display devices 1. FIG. 4 shows the flow of data gathered from multiple image display devices 1 to the internetwork 23, which are then communicated to a central server 24 and to a database 25. FIG. 4 also shows the flow of data communicated from the central server 24 to the individual image display devices 1.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An image display device comprising:
a) an advertising system;
b) a customer demographic data collection system; and
c) an information processing device that controls the advertising system and the customer demographic data collection system;
wherein the advertising system comprises an image display module and an audio reproduction module, wherein the advertising system retrieves image data and audio data from the information processing device and displays the image data with the image display module and reproduces the audio data with the audio reproduction module per control of the information processing device;
wherein the customer demographic data collection system comprises an video capture module that is adapted to capture video data and sends the captured video data to the information processing device; wherein the information processing device comprises a video mining module, a controlling module that controls the operation of the advertising system and the customer demographic data collection system, a networking module that sends/receives data over an internetwork;
wherein the video mining module analyzes the captured video data and produces customer demographic data; wherein the image display module comprises:
1) a case comprising an opening;
2) a luminous source image display displaying a first image, wherein the source image display is positioned within the case;
3) a focusing element receiving light from the source image display and focusing the light to form a second image that is viewable through the opening of the case, wherein the focusing element is positioned within the case;
4) a sensor that is adapted to sense the existence and/or position of the body part of a customer around the opening;
wherein the image display module displays the image data interactively according to the existence and/or position data obtained by the sensor.

2. The image display device of claim 1, wherein the customer demographic data produced by the video mining module comprises age range, gender, and ethnicity of the customers.

3. The image display device of claim 2, wherein the customer demographic data further comprises impression time of the customers.

4. The image display device of claim 3, wherein the advertising system further comprises a touch screen and a coupon portal, wherein the touch screen provides menus for selection by the customer, wherein the coupon portal prints out a predetermined coupon per selection of the customer.

5. The image display device of claim 4, wherein the customer demographic data further comprises number of coupons dispensed, and number of touch screen hits by the customer.

6. The image display device of claim 4, wherein the customer demographic data further comprises number of hits on the image displayed by the image display module.

7. The image display device of claim 4, wherein the customer demographic data further comprises number of users, time spent in a waiting queue, and total number of impressions.

8. The image display device of claim 1, wherein the image data and audio data are updated via the networking module.
